(19) United States
(12) Patent Application Publication
(10) Pub. No.: US 2020/0117745 A1
(43) Pub. Date: Apr. 16, 2020

(54) DYNAMIC DATA MOVEMENT USING APPLICATION RELATIONSHIPS WITH ENCRYPTION KEYS IN DIFFERENT ENVIRONMENTS

(71) Applicant: CA, Inc., New York, NY (US)

(72) Inventors: Vasanth Krishna PG, Bangalore (IN); Vipul Wadhawan, Bangalore (IN)

(73) Assignee: CA, Inc., New York, NY (US)

(21) Appl. No.: 16/157,359

(22) Filed: Oct. 11, 2018

(51) Int. Cl. G06F 17/30; G06F 17/27; G06F 21/62; G06F 21/60

(52) U.S. Cl. CPC G06F 17/30569; G06F 17/30292; G06F 17/30315; G06F 21/602; G06F 17/30389; G06F 17/2705; G06F 21/6227; G06F 17/30595

(57) ABSTRACT

A method by a computer of a computing system to import or export data while maintaining relationships is provided. A request is received export data from a source database or import data to a destination database. When the request is a request to export data, the export data and data to be excluded from exporting is determined. An extraction pointer to the export data and an exclusion pointer to the data to be excluded from export is determined. An export JSON object is created that includes export relationships, the location of the export data, the location of data to be excluded, and input values for source database tables that are designated as export visitable tables. The export visitable tables are prepared to support export of the export data, which is extracted to a designated format while preserving the export relationships the data to export has with the export visitable tables.

### FIELD

Some embodiments described herein relate to root cause analysis, and in particular, to recommending potential root causes of failure using a visual timeline.

### BACKGROUND

Programmers such as Information Technology (IT) personnel, product developers, product support personnel and others often receive requests for data export or data import across multiple environments. The request to export may be a request for a one-time extract of data, be based on a specified condition on a set of tables in a database, be a request for an extract of master data, be a request for a complete setup with dependency with an intent to import to a different environment, and the like.

The data is typically stored in databases. Different categories of data are in databases, such as master data, transaction data, and configuration data. The data may be encrypted to provide security and the encryption keys used to encrypt and decrypt the data varies between environments.

The programmers typically create a tool to perform the export and import of data so that subsequent export or import of the same data is quickly performed. However, schema changes (e.g., adding a column of data, dropping a column of data, adding a new dependency to an existing table, etc.) can occur any time during upgrades of products. This makes any existing tool written for performing the export/import of data of a product outdated or forced to upgrade to accommodate the changes in schema.

### SUMMARY

Some embodiments are directed to a method by a computer of a computing system for exporting data from a source database or importing data to a destination database. The method includes receiving a request to one of export data independently from a source database or import data independently to a destination database. Responsive to when the request is a request to export data from the source database, data to export and data to be excluded from exporting is determined. The source database is parsed to determine a location of the data to export and a location of the data to be excluded from export. The location of the data to export includes at least one extraction pointer to at least one column and a range of rows associated with each of the at least one column and the location of the data to be excluded from export comprises at least one exclusion pointer to at least one exclusion column Source database tables associated with the data to export and export relationships the data to export has with other data including the data to be excluded from export based on metadata is determined. The source database tables include a source database master table and source database configuration tables. An export java script object notation (JSON) object is created that comprises the export relationships, the location of the data to export, the location of data to be excluded from exporting, input values for the source database tables, and that designates the source database tables as export visitable tables. Based on the export JSON object, the export visitable tables to support export of the data to export are prepared and the data to export is extracted to a designated format by extracting the data while preserving the export relationships the data to export has with the export visitable tables.

The method for preparing an export visitable table may include creating a structured query language (SQL) statement from the export JSON object to read data from the source database. An input list is created for the export JSON object. Values of columns of the data to be extracted are binded. Execution of the SQL statement is initiated to extract the data from the source database into the export JSON configuration object. The extracted data is added to the export JSON object.

The method may further include decrypting an encrypted column to be exported using a unique key. The column is extracted after decryption. The column is encrypted after extraction using the unique key.

Corresponding computers configured to import and export data are disclosed. In some embodiments, the computer includes a processor and a memory coupled to the processor and storing computer readable program code that when executed by the processor causes the processor to perform operations includes receiving a request to one of export data independently from a source database or import data independently to a destination database. Responsive to when the request is a request to import data to the destination database, a pointer to data to be imported to a destination database is received. The data to be imported is moved to a predefined location. Import visitable tables associated with the data to import and import relationships the data to import has with other data based on metadata are determined. An import JSON object is created that includes the import relationships, the location of the data to import, identification of the visitable tables, and an identification of the destination database. For each of the visitable tables, a constraint on the visitable table is selected from a constraint cache. The constraint is applied on the data to import. A SQL query is created for the data to be imported. Creating the SQL query includes obtaining value meta data for creating the SQL query for each column of data in the data to be imported. Responsive to the column having a sequence enabled field, a sequence is set for the column. Responsive to the column being a foreign key, the value for the column is obtained from a reference table. Responsive to the column being configured for a replace list, the value is replaced in accordance with the import JSON object. Responsive to the column not having a sequence enable field or not being a foreign key or not being configured for the replace list, values of the data to be imported for the column are used. The SQL query is executed to import the data to be imported to the destination database.

The operations may further include determining whether the data to import is to be updated or is to be imported without being updated and responsive to the data to import is to be updated, obtain the constraint used for deciding the update. An update SQL query is created responsive to the data to import is to be updated and a SQL prepared query is created responsive to the data to import is to be imported without updating the data.

The operations may further include determining for each column in the data to import if the column is encrypted. Responsive to the column being imported is encrypted, a cryptographic key for the column is obtained. The column is decrypted using the cryptographic key prior to executing the SQL query. A determination is made as to whether the column is to be encrypted after being imported. Responsive to the column is to be encrypted after import, a second cryptographic key is obtained for encrypting the column after the column is imported. The column is encrypted after the column is imported using the second cryptographic key.

The operations may further include determining if a column of data in the data to export is sensitive data. Responsive to the column of data is sensitive data, the column of data is excluded from being exported. The operations to determine if a column of data is sensitive data include parsing each column of data in the data to export. For each column, the parsed data is compared to a pattern of sensitive data. Responsive to the parsed data matching the pattern of sensitive data, the column is designated as having sensitive data.

It is noted that aspects of the inventive concepts described with respect to one embodiment may be incorporated in different embodiments although not specifically described relative thereto. That is, all embodiments or features of any embodiments can be combined in any way and /or combination. These and other objects or aspects of the present inventive concepts are explained in detail in the specification set forth below.

Advantages that may be provided by various of the concepts disclosed herein include synchronizing environments where data is stored with different cryptographic keys, defining relations between tables independent of databases where the data is stored, adding or removing tables to an export list without having to entirely reprogram an extraction tool, and automating the import and export of data.

Other methods, devices, and computer program products, and advantages will be or become apparent to one with skill in the art upon review of the following drawings and detailed description. It is intended that all such additional systems, methods, or computer program products and advantages be included within this description, be within the scope of the present inventive concepts, and be protected by the accompanying claims.

### BRIEF DESCRIPTION OF THE DRAWINGS

The accompanying drawings are included to provide a further understanding of the disclosure and are incorporated in and constitute a part of this application. In the drawings:

FIG. 1 is a block diagram illustrating an example of an environment of a conversion system according to some embodiments.

FIGS. 2A-2C are exemplary signaling diagrams for illustrating procedures according to an embodiment.

FIG. 3 is a flowchart illustrating operations to determine if a column of data designated to be exported is sensitive data according to some embodiments.

FIG. 4 is a flowchart illustrating operations to prepare export visitable tables according to an embodiment.

FIG. 5 is a flowchart illustrating operations to prepare the export visitable tables according to some embodiments.

FIG. 6 is a flowchart illustrating operations to export encrypted data according to some embodiments.

FIG. 7 is a flowchart illustrating operations to import data that is to be updated according to some embodiments.

FIG. 8 is a flowchart illustrating operations to obtain value metadata for each column of data to be imported according to some embodiments.

FIG. 9 is a flowchart illustrating operations to create a SQL query based on overlay information according to some embodiments.

FIG. 10 is a flowchart illustrating operations to create a SQL query according to some embodiments.

FIG. 11 is a flowchart illustrating operations to import encrypted data according to some embodiments.

FIG. 12 is a block diagram illustrating relationships between data according to some embodiments.

FIG. 13 is a block diagram illustrating an example of a class diagram for exporting of data according to some embodiments.

FIG. 14 is a block diagram illustrating an example of a class diagram for importing of data according to some embodiments.

FIG. 15 is a block diagram of a conversion engine according to some embodiments.

### DETAILED DESCRIPTION OF EMBODIMENTS

Embodiments of the present inventive concepts now will be described more fully hereinafter with reference to the accompanying drawings. Throughout the drawings, the same reference numbers are used for similar or corresponding elements. The inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive concepts. As used herein, the term “or” is used nonexclusively to include any and all combinations of one or more of the associated listed items.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises,” “comprising,” “includes” or “including” when used herein, specify the presence of stated features, integers, steps, operations, elements, or components, but do not preclude the presence or addition of one or more other features, integers, steps, operations, elements, components, or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The inventors have realized problems with the conventional approaches of importing and exporting data. These problems include specific configurations may vary between environments, schema changes (e.g., adding a column, dropping a column, adding a new dependency to an existing table etc.) can occur at any time during upgrade of products, which makes any existing tool written for import or export of data outdated or forced to upgrade to accommodate the new changes in schema or relation. Additionally, columns in tables that are specific to environments should not be exported so that while doing an import it should not override the existing data. Other problems realized by the inventors will become apparent in the description herein.

Some embodiments described herein provide methods or computer systems for automating the export of data from a source database and importing of data to a destination database. According to some embodiments, a request to one of export data independently from a source database or import data independently to a destination database. Responsive to when the request is a request to export data from the source database, data to export and data to be excluded from exporting is determined. The source database is parsed to determine a location of the data to export and a location of the data to be excluded from export. The location of the data to export includes at least one extraction pointer to at least one column and a range of rows associated with each of the at least one column and the location of the data to be excluded from export comprises at least one exclusion pointer to at least one exclusion column Source database tables associated with the data to export and export relationships the data to export has with other data including the data to be excluded from export based on metadata is determined. The source database tables include a source database master table and source database configuration tables. An export java script object notation (JSON) object is created that comprises the export relationships, the location of the data to export, the location of data to be excluded from exporting, input values for the source database tables, and that designates the source database tables as export visitable tables. Based on the export JSON object, the export visitable tables to support export of the data to export are prepared and the data to export is extracted to a designated format by extracting the data while preserving the export relationships the data to export has with the export visitable tables. Responsive to when the request is a request to import data to the destination database, a pointer to data to be imported to a destination database is received. The data to be imported is moved to a predefined location. Import visitable tables associated with the data to import and import relationships the data to import has with other data based on metadata are determined. An import JSON object is created that includes the import relationships, the location of the data to import, identification of the visitable tables, and an identification of the destination database. For each of the visitable tables, a constraint on the visitable table is selected from a constraint cache. The constraint is applied on the data to import. A SQL query is created for the data to be imported. Creating the SQL query includes obtaining value meta data for creating the SQL query for each column of data in the data to be imported. Responsive to the column having a sequence enabled field, a sequence is set for the column Responsive to the column being a foreign key, the value for the column is obtained from a reference table. Responsive to the column being configured for a replace list, the value is replaced in accordance with the import JSON object. Responsive to the column not having a sequence enable field or not being a foreign key or not being configured for the replace list, values of the data to be imported for the column are used. The SQL query is executed to import the data to be imported to the destination database.

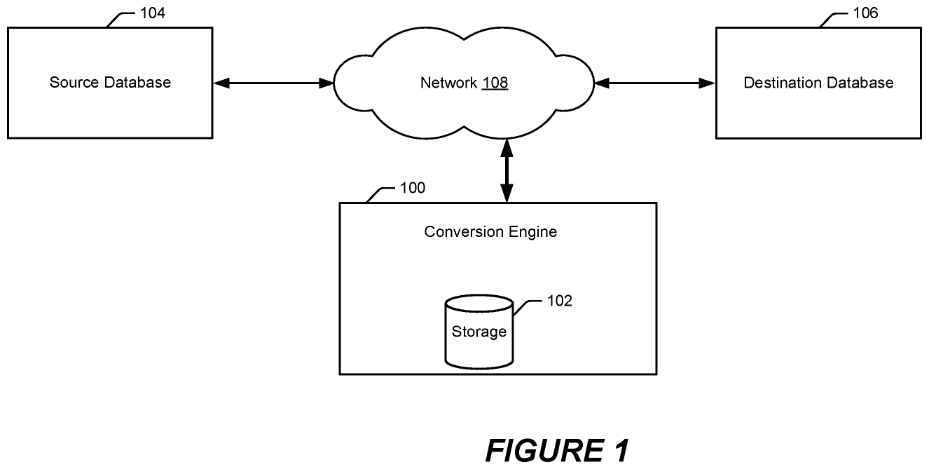

FIG. 1 is a block diagram illustrating an environment for importing and exporting data according to an embodiment. As shown, a conversion engine 100 having a storage component 102 communicates with a source database 104 and a destination database 106 via network 108. Network 106 may be a wired network, a wireless network, or a combination of a wired network and a wireless network.

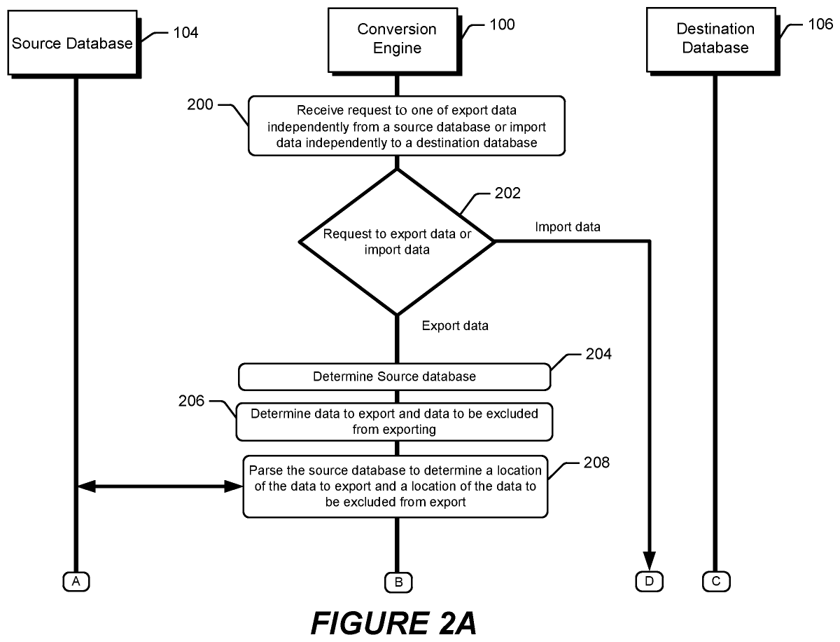

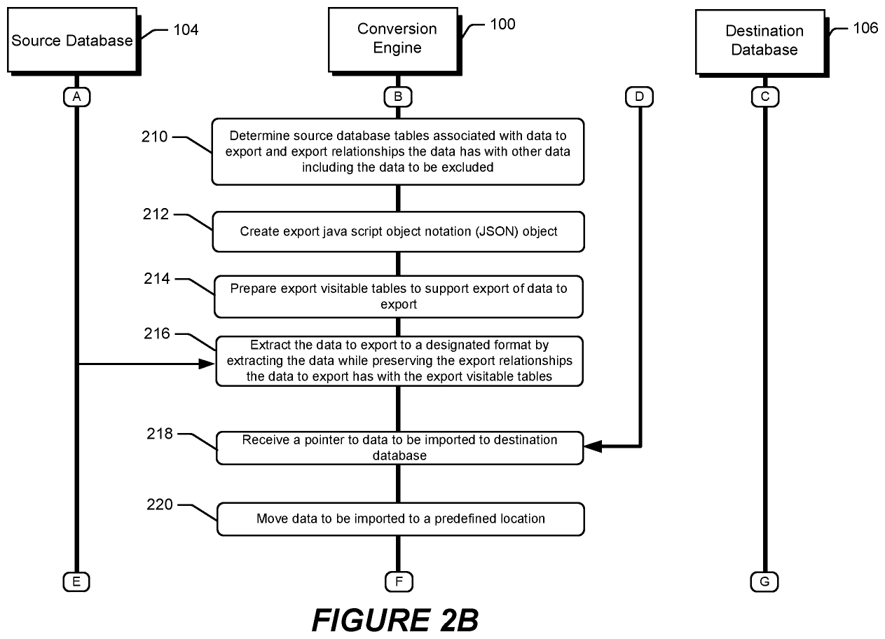

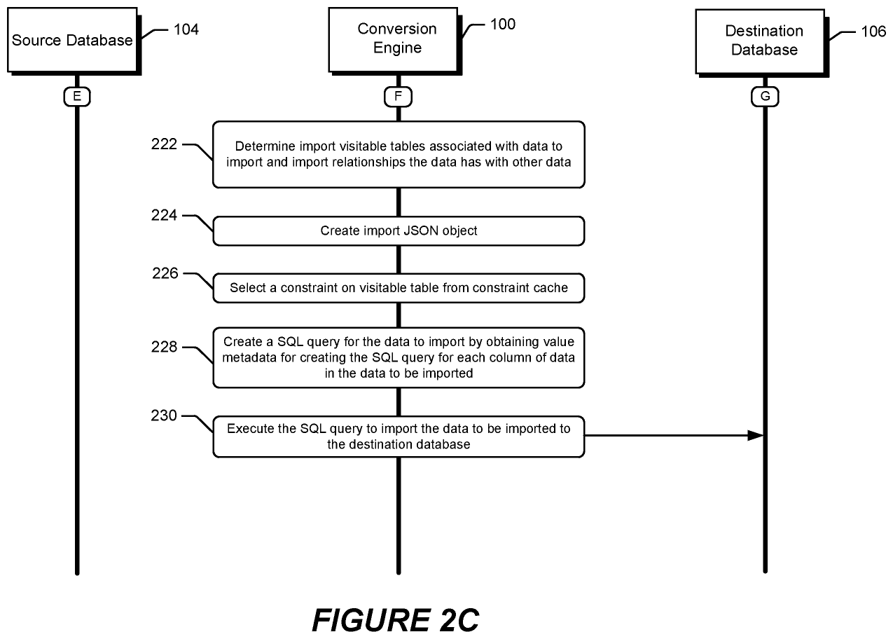

As further described in FIGS. 2A-2C, the conversion engine 100 communicates with source database 104 and CMDB 102. FIGS. 2A-2C are a signaling diagram of an exemplary procedure that includes reducing occurrence of errors when determining a root cause of failure of an operation. The procedures of FIGS. 2A-2C involve the conversion engine 100, the source database 104 and the destination database 106.

Initially, at operation 200, a request is received to export data independently from a source database or import data independently to a destination database. The request may be from a program, from a user, from a customer, etc. At operation 202, a determination is made as to whether the request is to export data or import data. The determination may be made by parsing the request to determine words in the request and compare the words to a list of words that indicate export and/or import.

At operation 204, when the request is to export data, the source database is determined. The identification of the source database may be in the request, may be identified by a product in the request where the product has a product database that stores the export data, etc. The identification may be performed by parsing the request to find the identification, searching a look-up table to find the source database associated with the export data, and the like.

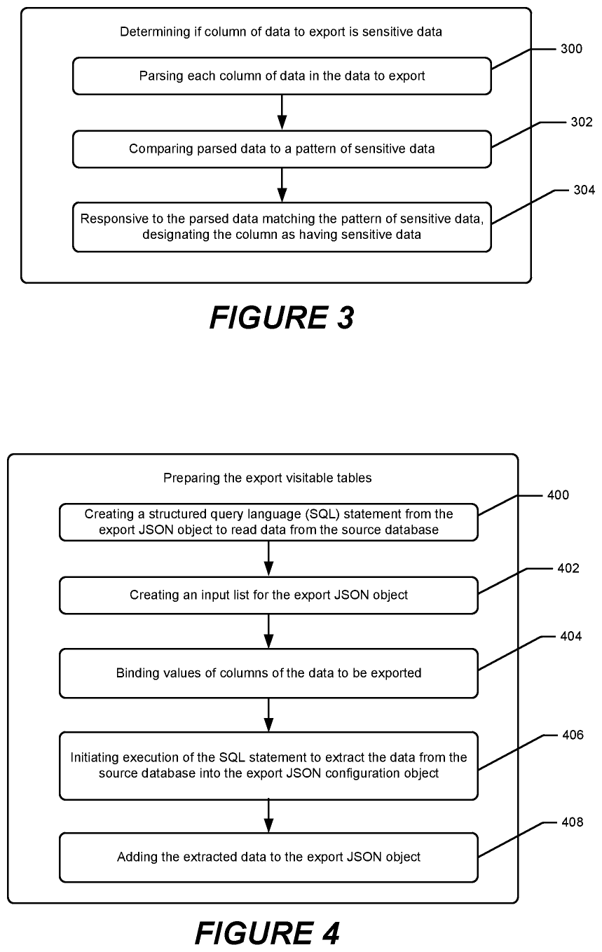

At operation 206, the data to export and the data to be excluded from exporting are determined. The data to export may be specified in the request, may be specified in a product database, etc. The data to be excluded may be specified in the request, may be specified in the source database, may be classified as sensitive data, may be specific to the source database, etc. Turning to FIG. 3, in one embodiment, the sensitive data has a pattern. For example, the social security number of an employee in an employee database may have a pattern of xxx-xx-xxxx where each x is a number. To determine if a column of data is sensitive, such as social security numbers, passport numbers, confidential data, etc., each column of data in the data to be exported is parsed at operation 300. At operation 302, the parsed data is compared to one or more patterns of sensitive data. Responsive to the parsed data matching a pattern of sensitive data, the column is designated as having sensitive data and is excluded from being exported.

Returning to FIG. 2A, at operation 208, the source database is parsed to determine a location of the data to export and a location of the data to be excluded from export. The location of the data to export can be at least one extraction pointer to at least one column of data in the source database and a range of rows in the source database with each row of the range of rows associated with at least one of the at least one column of data. The location of the data to be excluded from export may be at least one exclusion pointer to at least one column of data in the source database.

Turning to FIG. 2B, at operation 210, source database tables associated with the data to export and relationships the data to export has with other data including the data to be excluded. The source database tables may be master tables, transaction tables, and configuration tables. To determine the source database tables, the columns and/or rows of data to export are parsed to determine source database tables linked to the columns and/or rows. For example, if the source database is an employee database, the source data tables may be an employee table, a department table, and employee department table, etc. The source database tables associated with the data to export includes the linked source database tables. The relationships the data to export has may be found by parsing the columns and/or rows of data to export. For example, if the source database is an employee database, the relationship may be that an employee number is associated with a date of birth of the employee, with a first name of the employee, with a last name of the employee, with a gender of the employee, with a hire date of the employee, with a phone number of the employee, etc.

At operation 212, a Java script object notation (JSON) object is created for export of the data. The JSON object may include the relationships, the location of the data to export, the location of the data to be excluded from exporting, input values for the source database tables, and a designation of the source database tables that are to be visitable tables.

At operation 214, each of the visitable tables to support export of data to be exported are prepared. Turning to FIG. 4, at operation 400, preparing a visitable table includes creating a structure query language (SQL) statement from the JOSN object to read data from the source database. Creating the SQL statement in one embodiment includes converting the JSON object to the SQL statement based on parsing of the JSON object. At operation 402, an input list for the JSON object is created. At operation 404, values of the columns of data to be exported are binded. At operation 406, execution of the SQL statement is initiated to extract the data to be exported from the source database into the JSON configuration object. At operation 408, the extracted data is added to the JSON object.

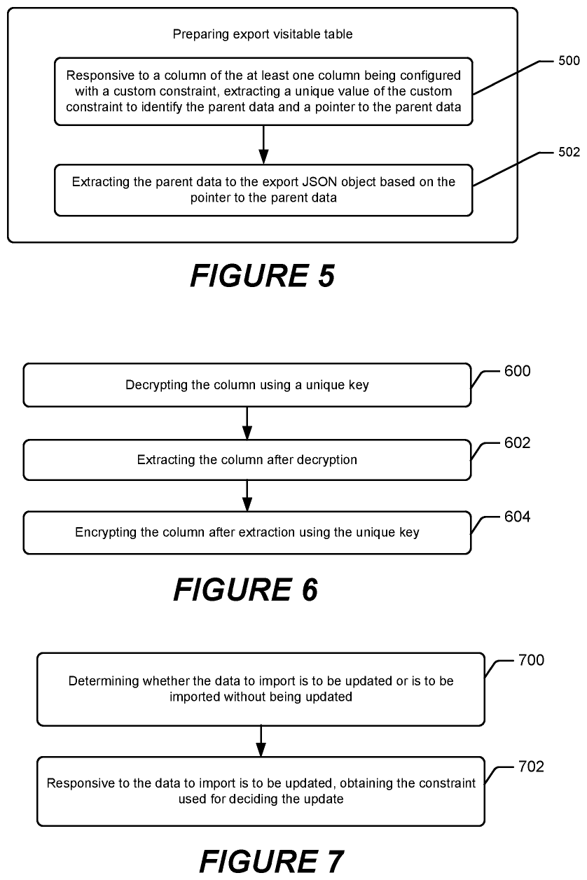

Turning to FIG. 5, preparing a visitable table may further include responsive to a column of the at least one column being configured with a custom constraint, extracting a unique value of the custom constraint to identify the parent data and a pointer to the parent data. The parent data is extracted to the JSON object based on the pointer to the parent data.

Returning to FIG. 2B, at operation 216, the data to export is extracted to export to a designated format by extracting the data while preserving the export relationships the data to export has with the visitable tables. For example, any column of data to export that is encrypted remains encrypted. Turning to FIG. 6, at operation 600, any column of data to export that is encrypted is decrypted using a unique key for the column of data. In one embodiment, the unique key is the cryptographic key used to encrypt the data. At operation 602, the column is extracted after decryption. At operation 604 the extracted column is encrypted using the unique key used to decrypt the column or with a different unique key.

Returning to FIG. 2B, when the determination in operation 202 is that the request is to import data, at operation 218, a pointer to the data to be imported to a destination database is received. At operation 220, the data to be imported is moved to a predefined location.

Turning to FIG. 2C, at operation 222, visitable tables associated with data to import and relationships the data has with other data is determined based on metadata. To determine the visitable tables, the columns and/or rows of data to import are parsed to determine tables linked to the columns and/or rows. For example, if the data includes employee data, the visitable tables may be an employee table, a department table, and employee department table, etc. The visitable tables associated with the data to import includes these visitable tables. The relationships the data to import has may be found by parsing the columns and/or rows of data to import. For example, if the data to import is employee data, then the relationships may be that an employee number is associated with a date of birth of the employee, with a first name of the employee, with a last name of the employee, with a gender of the employee, with a hire date of the employee, with a phone number of the employee, etc.

At operation 224, a JSON object for importing the data is created. The JSON object may include the relationships, the location of the data to import (e.g., a pointer to the predetermined location), identification of the visitable tables, and an identification of the destination database. The identification of the destination database may be specified in the request to import data.

Turning to FIG. 7, in one embodiment, a determination is made at operation 700 as to whether the data to be imported is to be updated or is to be imported without being updated. At operation 702, responsive to the data to import is to be updated, the constraint used for deciding the update is determined. In one embodiment, the JSON object also includes an indication of whether the data to be imported is to be updated or imported without being updated by including the constraint in the JSON object.

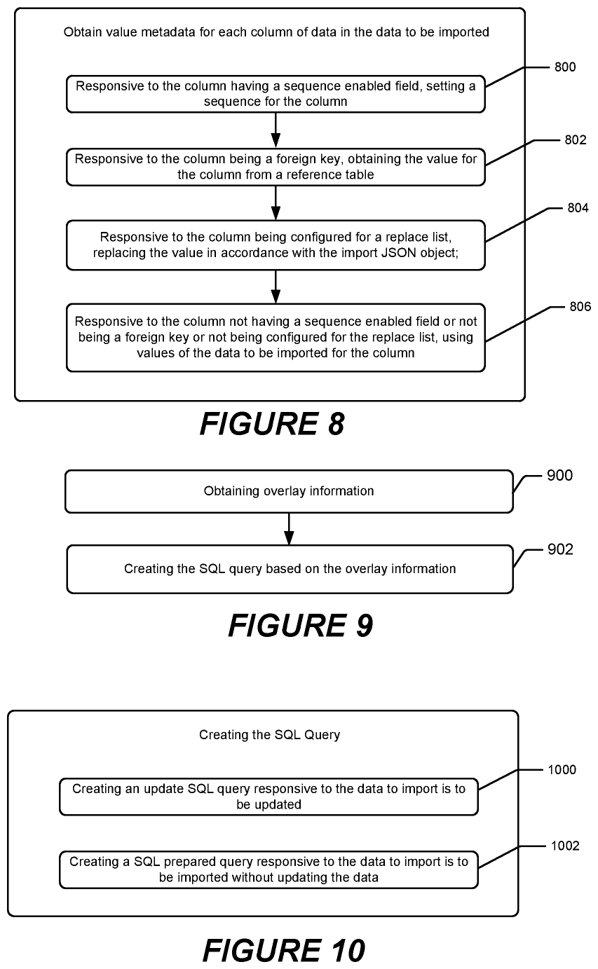

At operation 226, a constraint on each visitable table is selected from a constraint cache. The constraint is applied on the data to import. At operation 228, a SQL query is created for the data to import. Creating the SQL query includes obtaining value metadata for creating the SQL query for each column of data in the data to be imported. Turning to FIG. 8, obtaining the value metadata for each column includes responsive to the column having a sequence enabled field, setting a sequence for the column at operation 800. At operation 802, responsive to the column being a foreign key, obtaining the value for the column from a reference table. At operation 804, responsive to the column being configured for a replace list, replacing the value in accordance with the JSON object. At operation 806, responsive to the column not being a sequence enabled field or not being a foreign key or not being configured for the replace list, using values to the data to be imported for the column.

Turning to FIG. 9, in an embodiment, creating the SQL query includes obtaining overlay information for the data to be imported at operation 900. At operation 902, the SQL query is created based on the overlay information.

Turning to FIG. 10, in an embodiment, creating the SQL query includes creating an update SQL query responsive to the data to import is to be updated at operation 1000. At operation 1002, creating the SQL query includes creating a SQL prepared query responsive to the data to import is to be imported without updating the data.

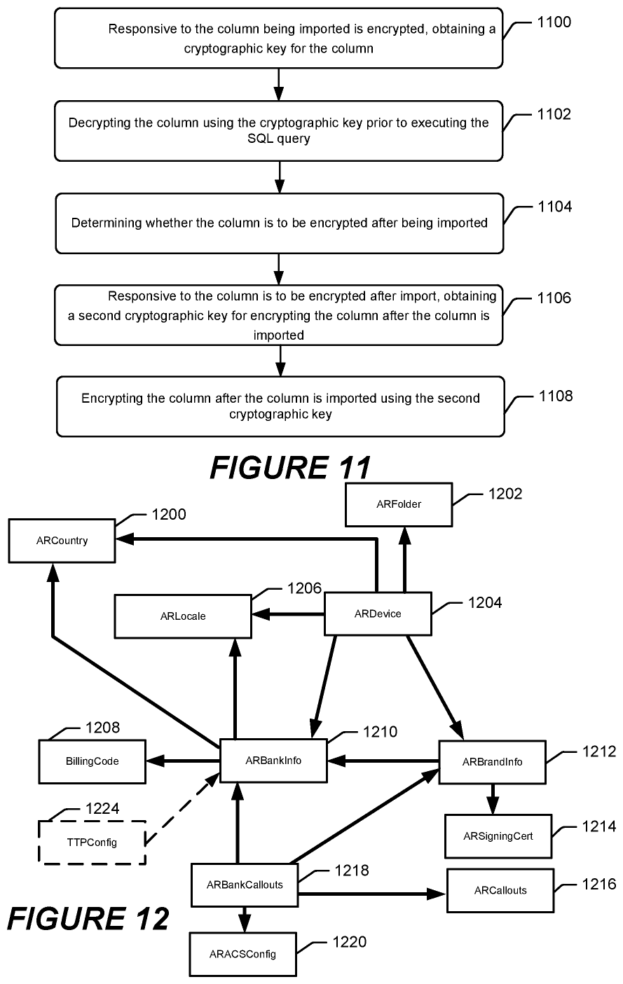

Returning to FIG. 2C, at operation 230, the SQL query is executed to import the data to be imported to the destination database. Turning to FIG. 11, in some embodiments, one or more columns of data to import is encrypted. Importing the data as encrypted may create issues in the destination database if the encryption key used to encrypt the data is not available at the location of the destination database. At operation 1100, responsive to the column being imported is encrypted, a cryptographic key is obtained for the column. At operation 1102, the column is decrypted using the cryptographic key prior to executing the SQL query. At operation 1104, a determination is made as to whether the column is to be encrypted after being imported. For example, the import request may indicate the column is to be encrypted after import, a list of columns may be specified that are to be kept encrypted may be accessed, etc. At operation 1106, responsive to the column is to be encrypted after import, a second cryptographic key is obtained for encrypting the column after the column is imported. At operation 1108, the column is encrypted after the column is imported using the second cryptographic key. This allows different encryption keys to be used.

An example of using the methods and computers described is illustrated in FIGS. 12-15. FIG. 12 illustrates an example of tables used in a database. As shown, tables 1200 to 1218 are associated with data to be exported and/or imported. For example, data may be imported from a master source database and imported into a copy of the database used to test programs. Any product schema contains master tables not related to any other tables but referred to by other tables and configuration tables. Examples of master tables in FIG. 12 include ARACSCONFIG 1220 and ARFOLDER 1202. Examples of configuration tables includes ARBANKINFO 1210, ARBRANDINFO 1212, ARDEVICE 1204, etc.

By applying a visitor design pattern to the tables 1200-1220 that are required for export, the tables needed to export the data can be considered as visitable objects. The class which is processing the exported data can considered as visitors. Considering tables as visitable objects solves the problem schema change impacts. All the tables to be visited tables results in the export of data to be readily configurable. This gives the flexibility of adding/removing tables to the export list.

To extract each bank table with dependency, then output of one table becomes input to extract from dependent table. The visitor pattern applied fits for both simple and complex requirements. When a product update adds another relation (e.g., TTPCONFIG 1222 to ARBANKINFO table 1210, then addition of the table to the visitable list will export the new relation without any code change. The combination of the visitor design pattern with the JSON object to SQL language as described above provides a solution to the problem identified of schema changes during an upgrade to a product.

For example, the JSON object format may be used to map the where clause fields with actual values. An example of JSON object format with the format illustrated below results in an easy to bind value. Any new column can be added to “where clause” without any change but with just configuration. On the other hand, when a SQL query is used, then a code change is required to bind the values. With format such as the JSON object format, the “json to sql” language will automatically bind the values along with actual data type taken from meta data cache. A sample of codes generated is illustrated below.

{
“operation”:“select”,
“columns”:“all”,
“from”:“ARBRANDINFO”,
“where”:[

{

“input”:“ARBANKINFO~BANKID”,
“condition”:“=”

},
{

“condition”:“or”

},
{

“searchcolumn”:“RANGEID”,
“condition”:“in”,
“innerquery”:{

“operation”:“select”,
“columns”:“CONFIGID”,
“from”:“ARBRANDINFO”,
“where”:{

“input”:“ARBANKINFO~BANKID”,
“condition”:“=”,
“endofinnerquery”:“yes”

}

}

}

]

}

The phases in exporting include:
a) The JSON SQL illustrated above will be translated to ======èselect* from ARBRANDINFO where BANKID=? or RANGEID in (select CONFIGID from ARBRANDINFO where BANKID=?)
b) Value list will be formed in following format:
   [ARBANKINFO#˜#BANKID#˜#NUMBER#˜#1#˜#24468, ARBANKINFO#˜#BANKID#˜#NUMBER#˜#2#˜#24468]
c) Before query execution the values are bind to actual column to the query index
d) Any new column addition will be automatically understood by the parser (along with required data type and index to bind) and no any code change required

When using formats such as a JSON format, the same functionality can be extended to other SQL, NoSQL, Excel, etc. formats which are storing data in tabular formats irrespective of database being used.

Developing a JSON language with following methods is required:
1) parseSQL: Converts JSON SQL to actual SQL statement.
   ex: Converts from following format
      {“operation”:“select”,“columns”:“all”,“from”:“ARBANKINFO”,“w here”:{“input”:“ARBANKINFO˜BANKDIRNAME”,“condition”:“=”}}
   To the actual SQL statement required for execution by the tool:
      select * from arbankinfo where bankdirname=?
2) prepareValueList:
   This provides a List from the JSON sql. The List contains input parameters required for the sql.
   Format:
   [TABLE_NAME#˜#COLUMN_NAME#˜#ORACLE_DATATYPE#˜#INDEX IN SQL#˜#VALUE]
   ex: for the above JSON SQL output from this method will be
   [ARBANKINFO#˜#BANKDIRNAME#˜#VARCHAR2#˜#1#˜#TEST BANK]
3) prepareSQL:
   This provides insert/update SQL for the JSON passed as an argument.

{

“ARBANKINFO”:{

“BANKID”:“0”,
“BANKDIRNAME”:“TESTBANK”,
Etc.

}
}

O/P:
INSERT INTO ARBANKINFO (BANKID, BANKDIRNAME) VALUES (?,?, . . . )

During the operations to export and import, the following items in memory cache need to be maintained at the initialization stage:

1) Meta data of tables used:
Ex: { ARBANKINFO={BANKDIRNAME={NULLABLE=Y,
DATA_LENGTH=50, DATA_TYPE=VARCHAR2},
BANKID={NULLABLE=Y, DATA_LENGTH=22, DATA_TYPE=NUMBER} . . . },ARBRANDINFO={ . . . }}
2) Unique configuration names ex. Bankdirname
3) Constraint cache:
   This should contain all the constraints of type (C, P, U, R) enabled in the tables.
   ARBANKINFO={ARBANKINFO_PK=P#˜#BANKID#˜#null#˜#null,
   ARBANKINFO_UK=U#˜#BANKDIRNAME#˜#null#˜#null}

Additionally, a custom constraint configuration option is used in one embodiment. A developer should be able to add additional constraint if required in the request received by the computer described herein. Custom constraint configuration may be in the form of JSON. The JSON Parser will convert the custom constraint configuration into an equivalent database constraint format. In the event that some tables in the source or destination database do not have Referential integrity (e.g., GUIDs) or primary key, the custom constraint will help us to maintain the data integrity during export/import of data. This handles situations where specific configurations vary between the source and destination environments.

An example of adding a custom referential constraint for a table and column is provided to add a referential constraint on column BANKID of table ARBRANDINFO. Similarly, Unique or Primary constraints can be added on the table. Any number of constraints can be added.

ARBRANDINFO_ADDITIONAL_CONSTRAINTS_1={

“ARBRANDINFO”:[

{

“ctype”:“R”,
“cname”:“ARBRANDINFO_C_BANKID_FK”,
“stable”:“ARBRANDINFO”,
“scolumn”:“BANKID”,
“rtable”:“ARBANKINFO”,
“rcolumn”:“BANKID”

}

]
}

Continuing the list of items in in memory cache that need to be maintained at the initialization stage:
4) Skip column cache. This cache specifies columns that are encrypted

Configuring optionally skips the columns specified from export when cryptographic keys are not available.
Example:
SKIP_COLUMN_LIST=ARBRANDINFO˜SIGNINGCERTFILE, ARBRANDINFO˜SIGNINGKEYFILE
5) Fuzzy login check fields. Having these fields enables export/import to be independent of the databases, including document based databases. If no data is found for a field, apply fuzzy logic configured
6) Replace column values while importing. Some columns in tables may be specific to environments. The columns determined to be specific to an environment may be required to be modified while importing. Related to the configured
   REPLACE_COLUMNVALUES_LIST=ARBRANDINFO˜ACSURL1
   Related to the configured parameter there is one or more configurations which indicates what the criteria is for replace. Replace might be partial replace, complete replace or like replace.
   REPLACE_VALUE_ARBRANDINFO_ACSURL1=C#˜#https://preview2.arcot.com/acspage/cap
Using the tables in FIGS. 12, the visitable tables for exporting determined as describes above are:
   ARBANKINFO,ARBRANDINFO,ARFOLDER,ARDEVICE,ARCALLO UTSCONFIG,ARBANKCALLLOUTS etc.
   Maintaining the SQL in JSON representation, a parser which will convert JSON SQL to SQL statement will result in easy data binding.

Parser should have two methods:
7) Column level encryption:
   If we maintain the columns which are encrypted using type of key (i.e.

either master key or bank key) then this solves the problem when a unique key used to identify a configuration or master data across issuer may not be same as a sequence ID generated by the database. Any new column if converted as encrypted by during product upgrade, then no code change is required by the tool, leading to automated conversion and automated import and export of data.
MASTERKEY_ENCRYPT_DECRYPT=ARCALLOUTSCONFIG˜INFOLIST,ARBANKINFO˜BANKKEY
BANKKEY_ENCRYPT_DECRYPT=ARBANKINFO˜CONFIGLIST,ARBANKINFO˜UPLOADKEY

The phases of execution to export are described above. An example of data after export is:

{

“Table-1”:{

“Column1”:“0”,
“Column2”:“1”,
....

“LOCALEID”:“R!~!LOCALEID!~!ARLOCALE!~!LOCALE!~!en

_GB”, ------------------------> This is the foreign key constraint column. his
means LOCALEID should be derived from en_GB. This enables export
and import to be independent of the database..

...

},
“Table-2”:[

{

“column1”:“−1”,
“columns2”:“4”,
....

},
.
.
.

“Table-n”:[
]

}

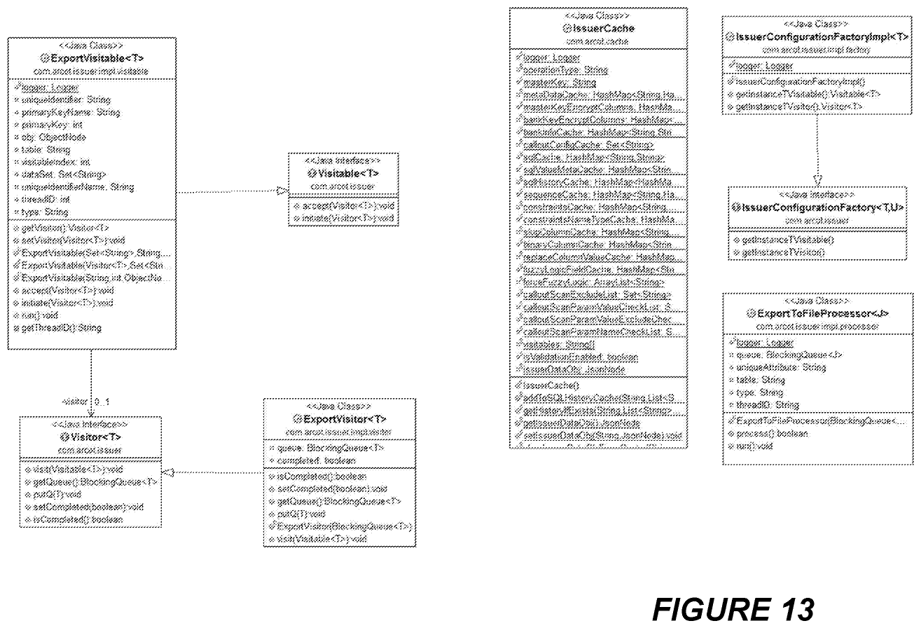

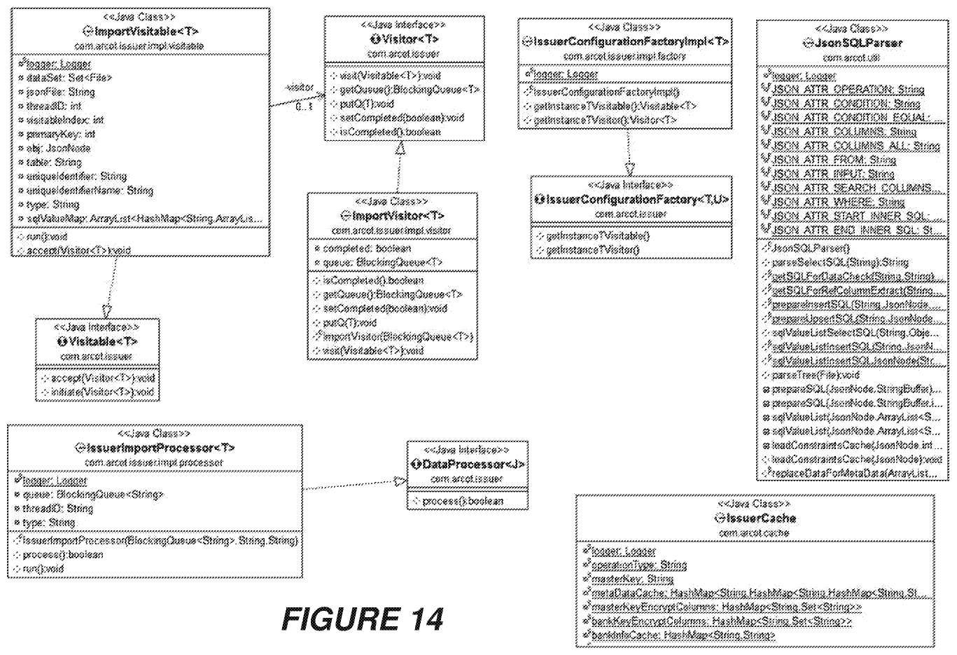

An example of the class diagram for the export is illustrated in FIG. 13. The phases of execution for import have been described above. An example of the class diagram for import is illustrated in FIG. 14.

Other examples of code generated by the conversion engine 100 for an embodiment of employee data is illustrated below:

EMPLOYEES Table:

CREATE TABLE “EMPLOYEES”

| | |
|---|---|
| ( | “EMPID” NUMBER(*,0), |

“DOB” DATE,
“FIRSTNAME” VARCHAR2(255 BYTE),
“LASTNAME” VARCHAR2(255 BYTE),
“GENDER” CHAR(1 BYTE),
“HIREDATE” DATE,
“PHONE” VARCHAR2(255 BYTE)

)

DEPARTMENTS Table

CREATE TABLE “DEPARTMENTS”

| | |
|---|---|
| ( | “DEPTNO” NUMBER(*,0), |

“DEPTNAME” VARCHAR2(255 BYTE)

)

EMPLOYEEDEPARTMENT Table

CREATE TABLE “EMPLOYEEDEPARTMENT”

| | |
|---|---|
| ( | “EMPID” NUMBER(*,0), |

“DEPT” VARCHAR2(255 BYTE),
“FROMDATE” DATE,
“TODATE” DATE

)

There is no constraint defined at the table level for the tables considered in this example.

### Configuration:

Visitable configuration (applicable for both export and import):
VISITABLES=EMPLOYEES,DEPARTMENTS,EMPLOYEEDEPARTMENT

Configuration for identifying encryption columns (applicable for both export and import):
MASTERKEY_ENCRYPT_DECRYPT=EMPLOYEES˜PHONE BANKKEY_ENCRYPT_DECRYPT=SKIP_COLUMN_LIST=

Configuration for any binary data column (in this example no binary columns like blob) (applicable for both export and import):
BINARY DATA=

File name for the exported file (applicable for both export):
CONFIGURATION_EXPORT_FILE=ConfigExport.j son

Configuration of custom constraint for each table (applicable for both export and import):

| | |
|---|---|
| 1. | Primary key Constraint for EMPLOYEES table: |
| | EMPLOYEES_ADDITIONAL_CONSTRAINTS={ |

“EMPLOYEES”:[

{

“ctype”:“P”,
“cname”:“EMPLOYEES_C_PK”,
“stable”:“EMPLOYEES”,
“scolumn”:“EMPID”,
“rtable”:“”,
“rcolumn”:“”

}

]

| | |
|---|---|
| | } |
| 2. | Primary key Constraint for DEPARTMENTS table: |
| | DEPARTMENTS_ADDITIONAL_CONSTRAINTS_CNT=2DEPARTMENTS_ADDITION |
| | AL_CONSTRAINTS_1={ |

“DEPARTMENTS”:[

{

“ctype”:“P”,
“cname”:“DEPARTMENTS_C_PK”,
“stable”:“DEPARTMENTS”,
“scolumn”:“DEPTNO”,
“rtable”:“”,
“rcolumn”:“”

}

]

| | |
|---|---|
| | } |
| 3. | Unique key Constraint for DEPARTMENTS table: |
| | DEPARTMENTS_ADDITIONAL_CONSTRAINTS_2={ |

“DEPARTMENTS”:[

{

“ctype”:“U”,
“cname”:“DEPARTMENTS_U_PK”,
“stable”:“DEPARTMENTS”,
“scolumn”:“DEPTNAME”,
“rtable”:“”,
“rcolumn”:“”

}

]

| | |
|---|---|
| | } |
| 4. | Foreign key Constraint for EMPLOYEEDEPARTMENT table EMPID column |
| | to Employee table EMPID column: |
| | EMPLOYEEDEPARTMENT_ADDITIONAL_CONSTRAINTS_CNT=2EMPLOYEEDEPAR |
| | TMENT_ADDITIONAL_CONSTRAINTS_1={ |

“EMPLOYEEDEPARTMENT”:[

{

“ctype”:“R”,
“cname”:“EMPLOYEEDEPARTMENT_C_EMPID_FK”,
“stable”:“EMPLOYEEDEPARTMENT”,
“scolumn”:“EMPID”,
“rtable”:“EMPLOYEES”,
“rcolumn”:“EMPID”

}

]

| | |
|---|---|
| | } |
| 5. | Foreign key Constraint for EMPLOYEEDEPARTMENT table DEPT column to |
| | DEPARTMENTS table DEPTNO column: |
| | EMPLOYEEDEPARTMENT_ADDITIONAL_CONSTRAINTS_2={ |

“EMPLOYEEDEPARTMENT”:[

{

“ctype”:“R”,
“cname”:“EMPLOYEEDEPARTMENT_C_DEPT_FK”,
“stable”:“EMPLOYEEDEPARTMENT”,
“scolumn”:“DEPT”,
“rtable”:“DEPARTMENTS”,
“rcolumn”:“DEPTNO”

}

]

}

Configuration for JSON SQL (applicable for both export):

| | |
|---|---|
| 1. | JSON SQL to export data from EMPLOYEES table: |
| | 1_EMPLOYEES_EXPORT_SQL_JSON={ |

“operation”:“select”,
“columns”:“all”,
“from”:“EMPLOYEES”,
“where”:{

“input”:“EMPLOYEES~EMPID”,
“condition”:“=”

}

| | |
|---|---|
| | } |
| 2. | JSON SQL to export data from DEPARTMENTS table: |
| | 1_DEPARTMENTS_EXPORT_SQL_JSON={ |

“operation”:“select”,
“columns”:“all”,
“from”:“DEPARTMENTS”,
“where”:{

“searchcolumn”:“DEPTNO”,
“condition”:“in”,
“innerquery”:{

“operation”:“select”,
“columns”:“DEPT”,
“from”:“EMPLOYEEDEPARTMENT”,
“where”:{

“input”:“EMPLOYEES~EMPID”,
“condition”:“=”,
“endofinnerquery”:“yes”

}

}

}

| | |
|---|---|
| | } |
| 3. | JSON SQL to export data from EMPLOYEEDEPARTMENT table: |
| | 1_EMPLOYEEDEPARTMENT_EXPORT_SQL_JSON={ |

“operation”:“select”,
“columns”:“all”,
“from”:“EMPLOYEEDEPARTMENT”,
“where”:{

“searchcolumn”:“EMPID”,
“condition”:“in”,
“innerquery”:{

“operation”:“select”,
“columns”:“EMPID”,
“from”:“EMPLOYEES”,
“where”:{

“input”:“EMPLOYEES~EMPID”,
“condition”:“=”,
“endofinnerquery”:“yes”

}

}

}

}

### Exported Data:

{

“EMPLOYEES” : {

“EMPID” : “200001”,
“DOB” : “09-MAR-82”,
“FIRSTNAME” : “Vasanth”,
“LASTNAME” : “Krishna”,
“GENDER” : “M”,
“HIREDATE” : “09-MAY-14”,
“PHONE” : “9845457777”

},
“DEPARTMENTS” : {

“DEPTNO” : “10001”,
“DEPTNAME” : “Deptartment-1”

},
“EMPLOYEEDEPARTMENT” : [

{

“EMPID” : “R!~!EMPID!~!EMPLOYEES!~!EMPID!~!200001”,
“DEPT” : “R!~!DEPT!~!DEPARTMENTS!~!DEPTNO!~!10001”,
“FROMDATE” : “09-MAY-10”,
“TODATE” : “NULL”

}

]

}

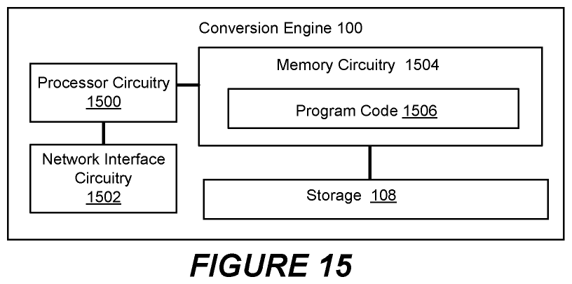

Turning now to FIG. 15, an overview diagram of a suitable computer hardware and computing environment in conjunction with which various embodiments of the conversion engine 100 may be practiced is illustrated. The description of FIG. 15 is intended to provide a brief, general description in conjunction with which the subject matter described herein may be implemented to provide the import and export of data while maintaining relationships to other data. In some embodiments, the subject matter is described in the general context of computer-executable instructions, such as program modules, being executed by a computer, such as a personal computer that provide the improvements described above. Generally, program modules include routines, programs, objects, components, data structures, and the like, that perform particular functions described above. Moreover, those skilled in the art will appreciate that the subject matter may be practiced with other computer system configurations, including hand-held devices, multiprocessor systems, microprocessor-based or programmable consumer electronics, network PCs, minicomputers, mainframe computers, and the like. As used herein, a “processor” includes one or more processors, microprocessors, computers, co-processors, graphics processors, digital signal processors, arithmetic logic units, system-on-chip processors, etc. The subject matter may also be practiced in distributed computer environments where tasks are performed by I/O remote processing devices that are linked through a communications network. In a distributed computing environment, program modules may be located in both local and remote memory storage devices.

In the embodiment shown in FIG. 15, a hardware and operating environment is provided that is applicable to the conversion engine 100 shown in the other figures. As shown in FIG. 15, one embodiment of the hardware and operating environment includes processing circuitry 1500 having one or more processing units coupled to the network interface circuitry 1502 and a memory circuitry 1504. The memory circuitry 1504 may include a ROM, e.g., a flash ROM, a RAM, e.g., a DRAM or SRAM, or the like and includes suitably configured program code 1606 to be executed by the processing circuitry so as to implement the above described functionalities of the conversion engine 100. The storage 108 may include a mass storage, e.g., a hard disk or solid-state disk, or the like. There may be only one or more than one processing unit, such that the processor circuitry 1500 comprises a single central-processing unit (CPU), or a plurality of processing units, commonly referred to as a multiprocessor or parallel-processor environment. A multiprocessor system can include cloud computing environments.

Thus, example systems, methods, and non-transitory machine readable media for reducing occurrences have been described. The advantages that may be provided by various of the concepts disclosed herein include synchronizing environments where data is stored with different cryptographic keys, defining relations between tables independent of databases where the data is stored, adding or removing tables to an export list without having to entirely reprogram an extraction tool, and automating the import and export of data.

As will be appreciated by one of skill in the art, the present inventive concepts may be embodied as a method, data processing system, or computer program product. Furthermore, the present inventive concepts may take the form of a computer program product on a tangible computer usable storage medium having computer program code embodied in the medium that can be executed by a computer. Any suitable tangible computer readable medium may be utilized including hard disks, CD ROMs, optical storage devices, or magnetic storage devices.

Some embodiments are described herein with reference to flowchart illustrations or block diagrams of methods, systems and computer program products. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations described herein may be written in an object-oriented programming language such as Java® or C++. However, the computer program code for carrying out operations described herein may also be written in conventional procedural programming languages, such as the “C” programming language. The program code may execute entirely on the user's computer, partly on the user's computer, as a standalone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments and, although specific terms are employed, they are used in a generic and descriptive sense only and not for purposes of limitation, the scope of the inventive concepts being set forth in the following claims.

What is claimed is:

1. A method by a computer of a computing system, the method comprising:
receiving a request to one of export data independently from a source database or import data independently to a destination database;
responsive to when the request is a request to export data from the source database, performing:
determining data to export and data to be excluded from exporting;
parsing the source database to determine a location of the data to export and a location of the data to be excluded from export, wherein the location of the data to export comprises at least one extraction pointer to at least one column of data in the source database and a range of rows, each row of the range of rows associated with at least one of the at least one column and the location of the data to be excluded from export comprises at least one exclusion pointer to at least one exclusion column of data in the source database;
determining source database tables associated with the data to export and export relationships the data to export has with other data including the data to be excluded from export based on metadata, the source database tables comprising a source database master table and source database configuration tables;
creating an export java script object notation (JSON) object that comprises the export relationships, the location of the data to export, the location of data to be excluded from exporting, input values for the source database tables, and that designates the source database tables as export visitable tables; and
based on the export JSON object:
preparing the export visitable tables to support export of the data to export; and
extracting the data to export to a designated format by extracting the data while preserving the export relationships the data to export has with the export visitable tables.

2. The method of claim 1 wherein preparing the export visitable tables comprises:
for each export visitable table:
creating a structured query language (SQL) statement from the export JSON object to read data from the source database;
creating an input list for the export JSON object;
binding values of columns of the data to be extracted;
initiating execution of the SQL statement to extract the data from the source database into the export JSON configuration object; and
adding the extracted data to the export JSON object.

3. The method of claim 2 wherein preparing the export visitable table further comprises
responsive to a column of the at least one column being configured with a custom constraint, extracting a unique value of the custom constraint to identify the parent data and a pointer to the parent data; and
extracting the parent data to the export JSON object based on the pointer to the parent data.

4. The method of claim 3 further comprising:
responsive to the column being encrypted:
decrypting the column using a unique key;
extracting the column after decryption;
encrypting the column after extraction using the unique key;

5. The method of claim 2 wherein creating the SQL statement comprises converting the export JSON object to the SQL statement based on parsing of the JSON object.

6. The method of claim 1, further comprising:
responsive to when the request is a request to import data to the destination database:
receiving a pointer to data to be imported to a destination database;
moving the data to be imported to a predefined location;
determining import visitable tables associated with the data to import and import relationships the data to import has with other data based on metadata;
creating an import JSON object that comprises the import relationships, the location of the data to import, identification of the visitable tables, and an identification of the destination database;
for each of the visitable tables:
selecting a constraint on the visitable table from a constraint cache;
applying the constraint on the data to import;
creating a SQL query for the data to import, wherein creating the SQL query comprises:
obtaining value meta data for creating the SQL query for each column of data in the data to be imported:
responsive to the column having a sequence enabled field, setting a sequence for the column;
responsive to the column being a foreign key, obtaining the value for the column from a reference table; responsive to the column being configured for a replace list, replacing the value in accordance with the import JSON object; and
responsive to the column not having a sequence enable field or not being a foreign key or not being configured for the replace list, using values of the data to be imported for the column; and
execute the SQL query to import the data to be imported to the destination database.

7. The method of claim 6 further comprising:
determining whether the data to import is to be updated or is to be imported without being updated;
responsive to the data to import is to be updated, obtaining the constraint used for deciding the update;
wherein creating the SQL query comprises:
creating an update SQL query responsive to the data to import is to be updated; and
creating a SQL prepared query responsive to the data to import is to be imported without updating the data.

8. The method of claim 6, further comprising obtaining overlay information, wherein creating the SQL query further comprises creating the SQL query based on the overlay information.

9. The method of claim 6, further comprising:
for each column in the data to import:
responsive to the column being imported is encrypted:
obtaining a cryptographic key for the column; and
decrypting the column using the cryptographic key prior to executing the SQL query.
determining whether the column is to be encrypted after being imported;
responsive to the column is to be encrypted after import:
obtaining a second cryptographic key for encrypting the column after the column is imported; and
encrypting the column after the column is imported using the second cryptographic key.

10. A computer configured to import and export data, the computer comprising:
a processor; and
a memory coupled to the processor and storing computer readable program code that when executed by the processor causes the processor to perform operations comprising:
receiving a request to one of export data independently from a source database or import data independently to a destination database;
responsive to when the request is a request to import data to the destination database:
receiving a pointer to data to be imported to a destination database;
moving the data to be imported to a predefined location;
determining import visitable tables associated with the data to import and import relationships the data to import has with other data based on metadata;
creating an import JSON object that comprises the import relationships, the location of the data to import, identification of the visitable tables, and an identification of the destination database
for each of the visitable tables:
selecting a constraint on the visitable table from a constraint cache;
applying the constraint on the data to import;
creating a SQL query for the data to import, wherein creating the SQL query comprises:
obtain value meta data for creating the SQL query for each column of data in the data to be imported:
responsive to the column having a sequence enabled field, setting a sequence for the column;
responsive to the column being a foreign key, obtaining the value for the column from a reference table; responsive to the column being configured for a replace list, replacing the value in accordance with the import JSON object; and
responsive to the column not having a sequence enable field or not being a foreign key or not being configured for the replace list, using values of the data to be imported for the column; and
executing the SQL query to import the data to be imported to the destination database.

11. The computer of claim 10, wherein the operations further comprise:
determining whether the data to import is to be updated or is to be imported without being updated;
responsive to the data to import is to be updated, obtain the constraint used for deciding the update;
wherein creating the SQL query comprises:
creating an update SQL query responsive to the data to import is to be updated and
creating a SQL prepared query responsive to the data to import is to be imported without updating the data.

12. The computer of claim 10, wherein the operations further comprise obtaining overlay information, wherein creating the SQL query further comprises creating the SQL query based on the overlay information.

13. The computer of claim 10, wherein the operations further comprise for each column in the data to import:
responsive to the column being imported is encrypted:
obtaining a cryptographic key for the column; and
decrypting the column using the cryptographic key prior to executing the SQL query.
determining whether the column is to be encrypted after being imported;
responsive to the column is to be encrypted after import:
obtaining a second cryptographic key for encrypting the column after the column is imported; and
encrypting the column after the column is imported using the second cryptographic key.

14. The computer of claim 10, wherein the operations further comprise:
responsive to when the request is a request to export data from the source database:
based on the request, determining data to export and data to be excluded from exporting;
parsing the source database to determine a location of the data to export and a location of the data to be excluded from export, wherein the location of the data to export comprises at least one extraction pointer to at least one column and a range of rows associated with each of the at least one column and the location of the data to be excluded from export comprises at least one exclusion pointer to at least one exclusion column;
determining source database tables associated with the data to export and export relationships the data to export has with other data including the data to be excluded from export based on metadata, the source database tables comprising a source database master table and source database configuration tables;
creating an export java script object notation (JSON) object that comprises the export relationships, the location of the data to export, the location of data to be excluded from exporting, input values for the source database tables, and that designates the source database tables as export visitable tables; and
based on the export JSON object:
preparing the export visitable tables to support export of the data to export; and
extracting the data to export to a designated format by extracting the data while preserving the export relationships the data to export has with the export visitable tables.

15. The computer of claim 14, wherein preparing the export visitable tables comprises further operations comprising:
for each export visitable table:
creating a structured query language (SQL) statement from the export JSON object to read data from the source database;
creating an input list for the export JSON object;
binding values of columns of the data to be extracted;
initiating execution of the SQL statement to extract the data from the source database into the export JSON configuration object; and
adding the extracted data to the export JSON object;

16. The computer of claim 15, wherein preparing the export visitable table comprises further operations comprising
responsive to a column of the at least one column being configured with a custom constraint, extracting a unique value of the custom constraint to identify the parent data and a pointer to the parent data; and
extracting the parent data to the export JSON object based on the pointer to the parent data.

17. The computer of claim 15 wherein creating the SQL statement comprises converting the export JSON object to the SQL statement based on parsing of the JSON object.

18. The computer of claim 14 wherein the operations further comprise:
responsive to a column in the data to be exported being encrypted:
decrypting the column using a unique key;
extracting the column after decryption;
encrypting the column after extraction using a second unique key.

19. The computer of claim 14, wherein the operations further comprise:
determining if a column of data in the data to export is sensitive data;
responsive to the column of data is sensitive data, excluding the column of data from being exported.

20. The computer of claim 19 wherein the operations to determine if a column of data is sensitive data comprises operations comprising:
parsing each column of data in the data to export;
for each column:
comparing parsed data to a pattern of sensitive data;
responsive to the parsed data matching the pattern of sensitive data, designating the column as having sensitive data.
